(19) United States
(12) Patent Application Publication
(10) Pub. No.: US 2023/0076149 A1
(43) Pub. Date: Mar. 9, 2023

(54) METHODS AND APPARATUS FOR DATA IMPUTATION OF A SPARSE TIME SERIES DATA SET

(71) Applicant: Walmart Apollo, LLC, Bentonville, AR (US)

(72) Inventors: Anirban CHATTERJEE, West Bengal (IN); Subhadip PAUL, West Bengal (IN); Vijay Srinivas AGNEESWARAN, Bangalore (IN); Uddipto DUTTA, Kolkata (IN); Yogesh YADAV, Jhansi (IN)

(21) Appl. No.: 17/677,839

(22) Filed: Feb. 22, 2022

(30) Foreign Application Priority Data
Aug. 24, 2021 (IN) 202141038261

(51) Int. Cl. G06N 3/04; G06N 3/08

(52) U.S. Cl. CPC G06N 3/0445; G06N 3/08

(57) ABSTRACT

In various examples, a system can obtain a first time series data set, the first time series data set including a plurality of data elements. Each data element can include value data and corresponding time data. Based on the first time series data set, the system can generate a second data set and a third dataset. The second dataset can indicate one or more data elements with missing value data and the third dataset can include extremeness data. The extremeness data can indicate an extremeness score for each data element of the plurality of data elements. Additionally, based on the first time series data set, the second data set and a third dataset, the system can implement a set of operations that generate a substitute value data for each data element of the one or more data elements that is missing value data.

### CROSS-REFERENCE TO RELATED APPLICATIONS

This application claims priority benefit from Indian Provisional Patent Application 202141038261, filed on Aug. 24, 2021, the aforementioned priority application being hereby fully incorporated by reference in its entirety.

### TECHNICAL FIELD

The disclosure relates generally to apparatus and methods for data imputation of a data asset with a degree of sparsity.

### BACKGROUND

Allocation of resources is important in the survivability and profit generation of an organization. In the ecommerce context, the allocation of resources, such as personnel, can greatly affect the efficiency of a retail business, as well as a customer's experience with the retail business. For example, after a customer places an order, the longer the customer has to wait to receive the order or have the item available for pickup, the greater the chance the customer's experience will become negative. In various examples, a retail business's ability to allocate resources can depend on the retail business's ability to forecast the demand of products offered by the retail business. However, demand forecasting is only as good as the data the demand forecast is based on. In many instances, the data used to forecast demand may have a degree of sparsity or have missing values. Data with a high level of sparsity can be due to sub-optimal manual data collection processes or technical glitches in the automated data collection system. Such data sparseness may significantly harm the performance of downstream demand forecasting applications.

In various examples, data imputation systems can predict or determine values missing from ground truth data sets. Conventionally, such data imputation systems are based on the assumption that data is smoothable or lack extreme events or observations. As such, such data imputation systems would be highly inaccurate in predicting values missing from ground truth data sets that include periodic, frequent or multiple extreme data events.

### SUMMARY

The embodiments described herein are directed to imputing values or data missing from obtained ground truth time-series data that includes period, frequent or multiple extreme events. As herein describe, an extreme event includes one or more extreme data elements or values. The apparatus and methods described herein may be applied to ground truth data that includes multiple extreme events or infrequent extreme events with a more Gaussian like distribution. Additionally, the apparatus and methods described herein may be applied to data forecasting applications, such as a demand forecasting application.

In accordance with various embodiments, exemplary systems may be implemented in any suitable hardware or hardware and software, such as in any suitable computing device. In some embodiments, the system includes one or more processors and a memory resource storing instructions. In such embodiments, the one or more processors execute the instructions which cause the one or more processors to obtain a first time series data set. In some implementations, the first time series data set includes a plurality of data elements and each data element including value data and corresponding time data. Additionally, the one or more processors execute the instructions which cause the one or more processors to, based on the first time series data set, generate a second data set and a third dataset. In various implementations, the second dataset can indicate one or more data elements of the plurality of data elements that are missing value data, and the third dataset can include extremeness data indicating an extremeness score for each data element of the plurality of data elements. Moreover, the one or more processors execute the instructions which cause the one or more processors to, based on the first time series data set, the second data set and a third dataset, implement a set of operations that generate a substitute value data for each data element of the one or more data elements that are missing value data.

In some embodiments, a method is provided that includes obtaining a first time series data set. In some implementations, the first time series data set includes a plurality of data elements and each data element including value data and corresponding time data. Additionally, the method includes, based on the first time series data set, generating a second data set and a third dataset. In various examples, the second dataset can indicate one or more data elements of the plurality of data elements that are missing value data, and the third dataset can include extremeness data indicating an extremeness score for each data element of the plurality of data elements. Moreover, the method includes, based on the first time series data set, the second data set and a third dataset, implement a set of operations that generate a substitute value data for each data element of the one or more data elements that are missing value data.

In yet other embodiments, a non-transitory computer readable medium has instructions stored thereon, where the instructions, when executed by at least one or more processors, cause a computing device to obtain a first time series data set. In some implementations, the first time series data set includes a plurality of data elements and each data element including value data and corresponding time data. Additionally, the one or more processors execute the instructions which cause the computing device to, based on the first time series data set, generate a second data set and a third dataset. In various implementations, the second dataset can indicate one or more data elements of the plurality of data elements that are missing value data, and the third dataset can include extremeness data indicating an extremeness score for each data element of the plurality of data elements. Moreover, the one or more processors execute the instructions which cause the computing device to, based on the first time series data set, the second data set and a third dataset, implement a set of operations that generate a substitute value data for each data element of the one or more data elements that are missing value data.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an example data forecasting system that includes a data imputation computing device;

FIG. 2 illustrates a block diagram of example data imputation computing device of FIG. 1 in accordance with some embodiments;

FIG. 3 is a block diagram illustrating examples of various portions of the data imputation computing device of FIG. 1 in accordance with some embodiments;

FIG. 4 an example architecture of a cell of a Recurrent Neural Network (RNN) in accordance with some embodiments;

FIG. 5A illustrates an example forward layer of the RNN in accordance with some embodiments;

FIG. 5B illustrates an example backward layer of the RNN in accordance with some embodiments;

FIG. 6 illustrates an example method that can be carried out by the data imputation computing device of FIG. 1;

FIG. 7 illustrates another example method that can be carried out by the data imputation computing device of FIG. 1; and

FIG. 8 illustrates yet another example method that can be carried out by the data imputation computing device of FIG. 1.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

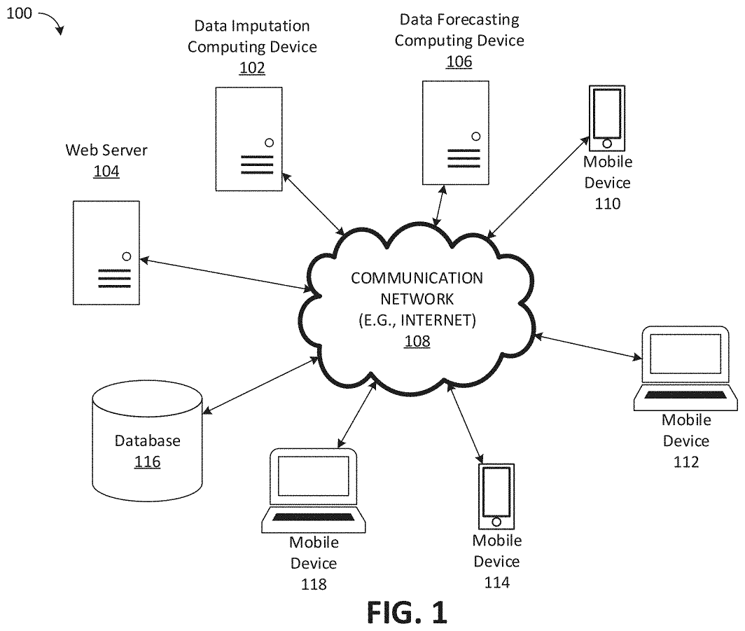

FIG. 1 illustrates a block diagram of an example data forecasting system 100 that includes a data imputation computing device 102 (e.g., a server, such as an application server), a web server 104, data forecasting computing device 106, database 116, multiple customer computing devices 110, 112, 114, and retailer computing device 118 operatively coupled over communication network 108. Data imputation computing device 102, web server 104, multiple customer computing devices 110, 112, 114, and retailer computing device 118 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 108.

In some examples, data imputation computing device 102 can be a computer, a workstation, a laptop, a server such as a cloud-based server, or any other suitable device. In some examples, each of multiple customer computing devices 110, 112, 114, and retailer computing device 118 can be a cellular phone, a smart phone, a tablet, a personal assistant device, a voice assistant device, a digital assistant, a laptop, a computer, or any other suitable device. In some examples, data imputation computing device 102 and retailer computing device 118 are operated by users of a retailer, and multiple customer computing devices 112, 114 are operated by customers of the retailer.

Although FIG. 1 illustrates three customer computing devices 110, 112, 114, data forecasting system 100 can include any number of customer computing devices 110, 112, 114. Similarly, data forecasting system 100 can include any number of data imputation computing device 102, web server 104, and database 116.

In some examples, web server 104 hosts one or more web pages, such as a retailer's website. Web server 104 may transmit purchase data related to orders purchased on the website by customers to retailer computing device 118. Web server 104 may also transmit a search request to retailer computing device 118. The search request may identify a search query provided by a customer. In response to the search request, retailer computing device 118 may execute a machine learning model (e.g., algorithm) to determine search results. The machine learning model may be any suitable machine learning model, such as one based on decision trees, linear regression, logistic regression, support-vector machine (SVM), K-Means, or a deep learning model such as a neural network. The machine learning model may execute with hyperparameters selected and tuned by retailer computing device 118. Retailer computing device 118 may then transmit the search results to the web server 104. Web server 104 may display the search results on the website to the customer. For example, the search results may be displayed on a search results webpage in response to the search query entered by the customer.

First customer computing device 110, second customer computing device 112, and N^{th} customer computing device 114 may communicate with web server 104 over communication network 108. For example, each of multiple customer computing devices 110, 112, 114 may be operable to view, access, and interact with a website hosted by web server 104. In some examples, web server 104 hosts a website for a retailer that allows for the purchase of items. The website may further allow a customer to search for items on the website via, for example, a search bar. A customer operating one of multiple customer computing devices 110, 112, 114 may access the website and perform a search for items on the website by entering in one or more terms into the search bar. In response, the website may return search results identifying one or more items, as described above and further herein. The website may allow the operator to add one or more of the items to an online shopping cart, and allow the customer to perform a “checkout” of the shopping cart to purchase the items.

Data imputation computing device 102 is further operable to communicate with database 116 over communication network 108. For example, data imputation computing device 102 can store data to, and read data from, database 116. Database 116 can be a remote storage device, such as a cloud-based server, a disk (e.g., a hard disk), a memory device on another application server, a networked computer, or any other suitable remote storage. Although shown remote to data imputation computing device 102, in some examples, database 116 can be a local storage device, such as a hard drive, a non-volatile memory, or a USB stick.

In some examples, database 116 stores order data received from web server 104. The order data can include data identifying one or more items purchased on an e-commerce platform, such as a website, by customers (e.g., via customer computing devices 110, 112, and 114). Additionally, the order data can include data identifying a time and/or date (e.g., a corresponding time stamp) of when each of the one or more items where purchased. Moreover, the order data can include data identifying a pickup location. In some examples, the pickup location can be a particular store. In such examples, the order data can include a store identifier indicating that particular store as the pickup location. Additionally, in such examples, the order data can include data identifying a time and/or date (e.g., a corresponding time stamp) of when each of the one or more items are ready or expected to be picked up at that particular pickup location.

In various implementations, database 116 can include aggregate order data. In such implementations, the order data can be aggregated to indicate the total number of orders expected to be picked at a particular store at a particular time. For example, the aggregate order data can indicate that 100,000 items are ready for pickup on Jul. 15, 2021. In various examples, the aggregate order data can be a time series data, where each data element of the plurality of data elements of the aggregate order data can include a value that represents the total amount of orders, a store identifier for a particular store, and a corresponding time element or time stamp (e.g., a particular time and date, or a particular date for pickup).

In some implementations, database 116 can include pre-processing data. Pre-processing can include missing value indicator data set and extremeness indicator data set of each time series data set that has a level of sparsity. In some implementations, missing value indicator data set can include data indicating which data elements of a particular time series data set is missing data/values. Additionally, missing value indicator data set can be generated by data imputation computing device 102, as data imputation computing device 102 pre-processes a time series data set to determine which data elements of the time series data set are missing data/values. In other implementations, extremeness indicator data set can include extremeness data. Extremeness data can indicate an extremeness score for each data element of the time series data set. Additionally, extremeness indicator data set can be generated by data imputation computing device 102, as data imputation computing device 102 processes a time series data set to determine an extremeness score for each data element of the time series data set are missing data/values.

In other implementations, database 116 can include reconstruction data. Reconstruction data can include data generated when data imputation computing device 102 implements one or more data reconstruction operations. As described below, in some implementations, data imputation computing device 102 can implement one or more data reconstruction operations to determine and generate substitute data to replace the missing data of a time series data. Additionally, in such implementations, data imputation computing device 102 can utilize preprocessing data when implementing the one or more data reconstruction operations to determine and generate the substitute data. In some examples, reconstruction data can include data associated with the determined predicted output values and/or corresponding extremeness scores.

In some implementations, database 116 may store the one or more machine learning models that, when executed by data forecasting computing device, enable data forecasting computing device 106 to determine/predict the level of demand or an order volume for a particular store in a future time. In some implementations, data forecasting computing device 106 can make future determinations or predictions based on aggregate order data or reconstructed order data.

Communication network 108 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 108 can provide access to, for example, the Internet.

Data imputation computing device 102 can implement one or more data reconstruction operations or processes to replace missing data with substituted data. In some implementations, the aggregate order data of a particular store may have some level of sparsity or missing data. In such implementations, the aggregate order data can be data imputation computing device 102 can be a time series data set. For example, a time series aggregate order data set can include a plurality of data elements x₀, x₁, x₂, x₃, x₄ . . . xₜ, where x=the total or aggregate order volume for a particular store ready or expected to be picked up at t=time element or time stamp. Further, the time series aggregate order data set may have one or more data elements that have missing data/value. For example, following the previous example, x₂, x₃ may have data identifying the order volume at t=2, 3 missing. Additionally, data imputation computing device 102 can implement the one or more data reconstruction operations to determine substitute data/value to replace the missing data/value, and generate a reconstructed time series data set that includes the substitute data in place of the missing data. In some examples, data imputation computing device 102 may implement the one or more data reconstruction operations using the original data of the time series aggregate order data set.

In some implementations, data imputation computing device 102 can implement one or more pre-processing operations or process using the original time series aggregate order data set. Additionally, the data imputation computing device 102 can implement the one or more pre-processing operations to extract or generate additional information or data that can be utilized in the one or more data reconstruction operations. In such implementations, data imputation computing device 102 may process and determine data that is missing from the original time series aggregate order data set. Additionally, data imputation computing device 102 can generate a second data set (e.g., m₁, m₂, . . . , mₙ) that indicates one or more data elements of the time series aggregate order data set that is missing data. In some examples, the second data set can include missing data/value indicators to indicate which data elements of the time series aggregate order data set is missing data/values. For example, an example time series aggregate order data set includes data elements x₁, x₂, x₃, x_{4.}, where x₃ is missing data indicating aggregate order volume at t=3. Data imputation computing device 102 can process the time series aggregate order data set to determine which data elements are missing data and generate a second set of data that indicates which data elements are missing data. In this example, “0” can represent or indicate which data elements of the time series aggregate order data set is missing data/value, and “1” can represent or indicate which data elements of the time series aggregate order data set has data/value. As such, the corresponding second data set can include data elements m₁, m₂, m₃, and m₄, where m₁, m₂, and m₄ all have a data value of “1”, while m₃ has the data value of “0.”

In various implementations, based on the original time series aggregate order data set, data imputation computing device 102 can implement the one or more pre-process operations to determine which data elements of the original time series aggregate order data set is “extreme” or an outlier. Additionally, data imputation computing device 102 can generate a third set of data (e.g., v₁, v₂, . . . , vₙ) that includes extremeness data. The extremeness data can include an extremeness indicator or score associated with each data element of the original time series data. In some implementations, data imputation computing device 102 can determine an extremeness score for each data element of the time series aggregate order data set based on a normality threshold. In such implementations, the normality threshold can be based on the standard deviation of a mean value of the time series aggregate order data set.

In some implementations, data imputation computing device 102 can implement one or more data reconstruction operations using the original time series aggregate order data set, the second data set and the third data set. Additionally, data imputation computing device 102 can reconstruct the original time series dataset (e.g., the time series aggregate order data) or generate a reconstructed time series data set that includes the data elements of the original time series dataset and the substitute data or value. In some examples, based on the substitute values, the data imputation computing device 102 may generate a new or substitute data elements with the substitute values to replace the corresponding data elements with the missing data/values. In other examples, data imputation computing device 102 may add the generated substitute value to the corresponding data element with the missing data/value.

Data forecasting computing device 106 can utilize the reconstructed time series data set(s) to train machine learning models (e.g., algorithms). The trained machine learning models may generate order volume forecasts or demand forecasts for a store. In various implementations, data forecasting computing device 106 may apply the trained machine learning models to the reconstructed time series dataset to generate an order volume forecast for a particular store. The machine learning model may be any suitable machine learning model, such as one based on decision trees, linear regression, logistic regression, support-vector machine (SVM), K-Means, or a deep learning model such as a neural network. The machine learning model may execute with hyperparameters selected and tuned by data forecasting computing device 106. Additionally, data forecasting computing device 106 may provide the order volume forecast(s) of the store to retailer computing device 118. Retailer computing device 118 may then implement one or more operations for allocating resources to that store based on the order volume forecast(s) of that store.

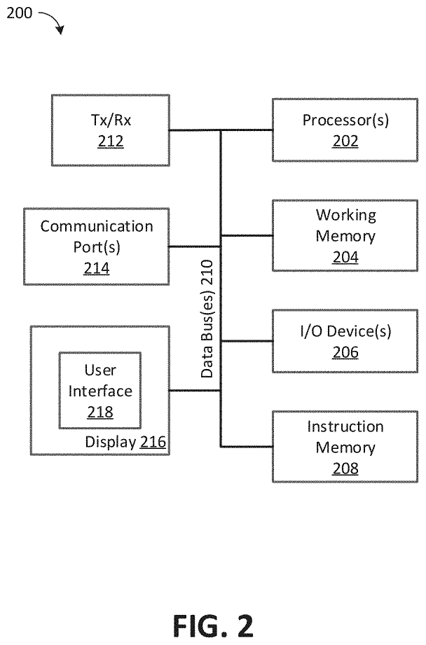

FIG. 2 illustrates a block diagram of example data imputation computing device 102 of FIG. 1. Data imputation computing device 102 can include one or more processors 202, working memory 204, one or more input/output devices 206, instruction memory 208, a transceiver 212, one or more communication ports 214, and a display 216, all operatively coupled to one or more data buses 210. Data buses 210 allow for communication among the various devices. Data buses 210 can include wired, or wireless, communication channels.

Processors 202 can include one or more distinct processors, each having one or more cores. Each of the distinct processors can have the same or different structure. Processors 202 can include one or more central processing units (CPUs), one or more graphics processing units (GPUs), application specific integrated circuits (ASICs), digital signal processors (DSPs), and the like.

Instruction memory 208 can store instructions that can be accessed (e.g., read) and executed by processors 202. For example, instruction memory 208 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. Processors 202 can be configured to perform a certain function or operation by executing code, stored on instruction memory 208, embodying the function or operation. For example, processors 202 can be configured to execute code stored in instruction memory 208 to perform one or more of any function, method, or operation disclosed herein.

Additionally, processors 202 can store data to, and read data from, working memory 204. For example, processors 202 can store a working set of instructions to working memory 204, such as instructions loaded from instruction memory 208. Processors 202 can also use working memory 204 to store dynamic data created during the operation of data imputation computing device 102. Working memory 204 can be a random access memory (RAM) such as a static random access memory (SRAM) or dynamic random access memory (DRAM), or any other suitable memory.

Input/output devices 206 can include any suitable device that allows for data input or output. For example, input/output devices 206 can include one or more of a keyboard, a touchpad, a mouse, a stylus, a touchscreen, a physical button, a speaker, a microphone, or any other suitable input or output device.

Communication port(s) 214 can include, for example, a serial port such as a universal asynchronous receiver/transmitter (UART) connection, a Universal Serial Bus (USB) connection, or any other suitable communication port or connection. In some examples, communication port(s) 214 allows for the programming of executable instructions in instruction memory 208. In some examples, communication port(s) 214 allow for the transfer (e.g., uploading or downloading) of data, such as interaction data, product data, and/or keyword search data.

Display 216 can display user interface 218. User interface 218 can enable user interaction with data imputation computing device 102. For example, user interface 218 can be a user interface for an application of a retailer that allows a customer to view and interact with a retailer's website. In some examples, a user can interact with user interface 218 by engaging input/output devices 206. In some examples, display 216 can be a touchscreen, where user interface 218 is displayed on the touchscreen.

Transceiver 212 allows for communication with a network, such as the communication network 108 of FIG. 1. For example, if communication network 108 of FIG. 1 is a cellular network, transceiver 212 is configured to allow communications with the cellular network. In some examples, transceiver 212 is selected based on the type of communication network 108 data imputation computing device 102 will be operating in. Processor(s) 202 is operable to receive data from, or send data to, a network, such as communication network 108 of FIG. 1, via transceiver 212.

### Data Imputation

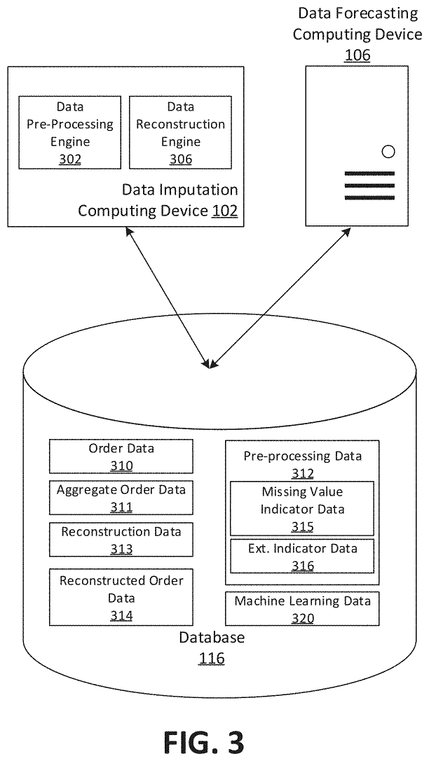

FIG. 3 is a block diagram illustrating examples of various portions of the data imputation computing device of FIG. 1. As illustrated in FIG. 3, data imputation computing device 102 can include pre-processing engine 302 and data reconstruction engine 306. In some examples, one or more of pre-processing engine 302 and data reconstruction engine 306 may be implemented in hardware. In other examples, one or more of pre-processing engine 302 and data reconstruction engine 306 may be implemented as an executable program maintained in a tangible, non-transitory memory, such as instruction memory 208 of FIG. 2, that may be executed by one or more processors, such as processor 202 of FIG. 2.

Additionally, in various implementations, database 116 of FIG. 3, may store order data 310, aggregate order data 311, pre-processing data 312, reconstruction data 313 and reconstructed order data 314. Order data 310 can include data identifying one or more orders purchased on an e-commerce platform, such as a website, by customers (e.g., via customer computing devices 110, 112, and 114). Additionally, order data 310 can include data identifying a time and/or date (e.g., a corresponding time stamp) of when each of the one or more items where purchased. Moreover, order data 310 can include data identifying a pickup location. In some examples, the pickup location can be a particular store. In such examples, order data 310 can include a store identifier indicating that particular store as the pickup location. Additionally, in such examples, order data 310 can include data identifying a time and/or date (e.g., a corresponding time stamp) of when each of the one or more items are ready or expected to be picked up at that particular pickup location.

Aggregate order data 311 includes aggregated order data 310. In some implementations, aggregate order data 311 can include data indicating the total number of orders expected to be picked at a particular store at a particular time. In various examples, the aggregate order data can be a time series data. In such examples, the aggregate order data can include a plurality of data elements. Additionally, each data element of the plurality of data elements can include a value or value data that represents the total amount of orders, a store identifier for a particular store, and a corresponding time element or time stamp (e.g., a particular time and date, or a particular date for pickup or when the orders represented in that data element are ready for pickup). In examples where the aggregate order data 311 is a times series data (e.g., a time series aggregate order data 311), aggregate order data 311 can include a first data element indicating 100,000 items are ready or expected to be ready for pickup at store A on Jul. 15, 2021; a second data element indicating 95,000 items are ready or expected to be ready for pickup at store A on Jul. 16, 2021, and a third data element indicating 103,000 items are ready or expected to be ready for pickup at store A on Jul. 17, 2021.

In various implementations, aggregate order data 311 may have missing data/values. In such implementations, data imputation computing device 102 can implement one or more data reconstruction operations or processes to replace the missing data with substitute data. In various examples, data imputation computing device 102 can generate reconstructed order data 314, which includes the substitute data. In some examples, the reconstructed order data 314, may include the data elements of the aggregate order data 311 and substitute data elements including the substitute data in place of the data elements of the aggregate order data 311 that have missing data/value(s). In other examples, the reconstructed order data 314 may include the data elements of the aggregate order data 311 and substitute data added to each of the corresponding data elements of the aggregate order data 311 that have missing data/elements.

In various implementations, database 116 store machine learning data 320 identifying and characterizing one or more machine learning models. In various implementations, data forecasting computing device 106 may utilize aggregate order data 311 and a machine learning model of machine learning data 320 to determine and generate order volume forecast(s) for a particular store. However, in examples where the aggregate order data 311 has missing data, data forecasting computing device 106 may utilize the corresponding reconstructed order data 314 and a machine learning model of machine learning data 320 to determine and generate order volume forecast(s) for a particular store.

In some implementations, aggregate order data 311 of a particular store may be a time series data set. For example, a time series data set can include a plurality of data elements x₀, x₁, x₂, x₃, x₄ . . . xₜ, where x=the aggregate order volume for a particular store at t=time. Additionally, the time series aggregate order data 311 may have some level of sparsity or missing data. For example, following the previous example, x₂, x₃ may have data identifying the order volume at t=2, 3 missing. In such implementations, data imputation computing device 102 may utilize the time series aggregate order data 311 to determine and generate substitute data/values and generate a reconstructed time series aggregate order data 311 (or reconstructed order data 314) that includes the substitute data/values in place of the missing data.

Pre-processing data 312 can include missing value indicator data 315 and extremeness indicator data 316. In some implementations, missing value indicator data 315 can include data indicating which data elements of a particular time series data set is missing data/values. Additionally, missing value indicator data 315 can be generated by pre-processing engine 302, as pre-processing engine 302 processes a time series data set, such as time series aggregate order data 311, to determine which data elements of the time series data set are missing data/values. In other implementations, extremeness indicator data 316 can include extremeness data. Extremeness data can indicate an extremeness score for each data element of the time series data set. Additionally, extremeness indicator data 316 can be generated by pre-processing engine 302, as pre-processing engine 302 processes a time series data set, such as time series aggregate order data 311, to determine an extremeness score for each data element of the time series data set are missing data/values.

Reconstruction data 313 can include data generated during the implementation of the one or more data reconstruction operations. As described below, in some implementations, data reconstruction engine 306 can implement one or more data reconstruction operations to determine and generate substitute data to replace the missing data of a time series data, such as time series aggregate order data 311. Additionally, in such implementations, data reconstruction engine 306 can utilize preprocessing data when implementing the one or more data reconstruction operations to determine and generate the substitute data. In some examples, reconstruction data 313 can include data associated with the determined predicted output values and/or corresponding extremeness scores.

Pre-processing engine 302 can implement one or more pre-preprocessing operations to process time series aggregate order data 311 with missing data/value(s) to determine and generate additional information for the data reconstruction process implemented by data reconstruction engine 306. In some implementations, pre-processing engine 302 can implement the one or more pre-processing operations to process and determine data that is missing from the time series aggregate order data 311. Additionally, pre-processing engine 302 can generate a second data set (e.g., m₁, m₂, . . . , mₙ) or missing value indicator data 315 that indicates one or more data elements of aggregate order data 311 that is missing data/value(s). In some examples, the second data set can include missing data/value indicators to indicate which data elements of the time series aggregate order data 311 set is missing data/values. For example, an example time series aggregate order data 311 includes data elements x₁, x₂, x₃, x₄, where x₃ is missing data indicating aggregate order volume at t=3. Pre-processing engine 302 can process the aggregate order data 311 to determine which data elements are missing data and generate a second set of data that indicates which data elements are missing data. For example, “0” can represent or indicate which data elements of the original time series data is missing data/value, and “1” can represent or indicate which data elements of the original time series data has data/value. As such, the second data set corresponding to the example time series aggregate order data 311 can include data elements m₁, m₂, m₃, and m₄, where m₁, m₂, and m₄ all have a data value of “1”, while m₃ has the data value of “0.”

In some implementations, pre-processing engine 302 can implement the one or more pre-processing operations to process and determine which data elements of the time series aggregate order data 311 is “extreme” or an outlier. Further, pre-processing engine 302 can generate a third set of data (e.g., v₁, v₂, . . . , vₙ) or extremeness indicator data 316 that includes extremeness data. The extremeness data can include an extremeness indicator or score associated with each data element of time series aggregate order data 311. In various implementations, pre-processing engine 302 can determine an extremeness score for each data element of time series aggregate order data 311 by determining a normality threshold based on the standard deviation of a mean value of time series aggregate order data 311. For example, the extremeness score, vₜ may be defined as follows:

$${v}_{t} = \{ \begin{matrix}0 & if {ϵ}_{1} \leq {x}_{t} \leq {ϵ}_{2} \\ {x}_{t} - {ϵ}_{2} & if {x}_{t} > {ϵ}_{2} \\ {x}_{t} - {ϵ}_{1} & if {x}_{t} < {ϵ}_{1}\end{matrix}$$

where ε₁=μ−2σ; and
ε₂=μ+2σ.

Data reconstruction engine 306 can implement one or more data reconstruction operations to determine and generate substitute data to replace the missing data of time series aggregate order data 311. In some implementations, data reconstruction engine 306 can utilize the original time series aggregate order data 311 in the data reconstruction process. Additionally, data reconstruction engine 306 can also utilize a corresponding second data set indicating which data elements of the time series aggregate order data 311 is missing data/value(s), and a corresponding third data set including extremeness data.

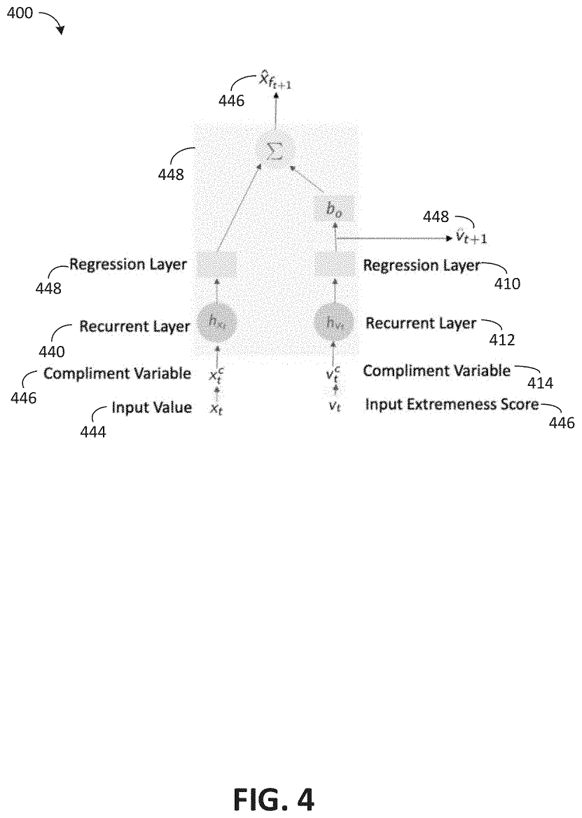

In some implementations, data reconstruction engine 306 can utilize a Recurrent Neural Network (RNN) in the implementation of the one or more data reconstruction operations. In such implementations, data reconstruction engine 306 may utilize a two separate bi-directional Long Short-Term Memory (LSTM) network to determine and generate missing data/values of a time series aggregate order data 311 with missing data/values. FIG. 4 illustrates an example architecture of a cell of a RNN. As illustrated in FIG. 4, the RNN cell 420 can have a recurrent layer (e.g., 406, 416) and regression layer (408, 422). The RNN cell 420 can determine a predicted output value 410, and corresponding predicted extremeness score 415 by processing input value 402 of a data element of an original time series data (e.g., value or value data of a data element of time series aggregate order data 311) and input extremeness score 404 (e.g., corresponding extremeness score of the data element of time series aggregate order data 311). Given, the possible missing values in the original time series data (e.g., time series aggregate order data 311), a “complement input value 404” (e.g., x^{c}ₜ) is utilized instead of input value 402. Similarly, a “complement input value 414” (e.g., v^{c}ₜ) is utilized when input extremeness score 404 (vₜ) is missing. As such, the RNN cell 420 can determine the predicted output value 410 and corresponding predicted extremeness score 415 according to the following equations.

\hat{x}ₜ=Wₓhₓ_{ₜ₋₁}+bₓ (2)

xₜ^{c}=mₜ·xₜ+(1−mₜ)·\hat{x}ₜ (3)

γₓ_{ₜ}=exp{−max(0,Wₓ_{_{γ}}δₜ+b_{γ})} (4)

hₓ_{ₜ}=σ(Wₕ[hₓ_{ₜ₋₁}⊙γₓ_{ₜ}]+Uₓ_{ₕ}[xₜ^{c}ºmₜ]+b_{b}) (5)

\hat{v}ₜ=Wᵥhᵥ_{ₜ₋₁}+bᵥ (6)

vₜ^{c}=mₜ·vₜ+(1−mₜ)·vₜ (7)

γ_{O}_{ₜ}=exp{−max(0,Wᵥ_{_{γ}}δₜ+b_{γ}_{ᵥ})} (8)

hᵥ_{ₜ}=σ(Wᵥ_{ₕ}[hᵥ_{ₜ₋₁}⊙γᵥ_{ₜ}]+Uᵥ_{_{b}}[vₜ^{c}ºmₜ]+bᵥ_{_{b}}) (9)

\hat{x}_{f}_{ₜ}=\hat{x}ₜ+b_{O}_{ₜ}\hat{v}ₜ (10)
where:
   equation (2) represents the regression layer 408;
   equation (5) represents the recurrent layer 406;
   equation (6) represents the regression layer 418;
   equation (9) represents the recurrent layer 416;
   º indicates concatentation operation;
   \hat{x}_{f}_{ₜ}
   \hat{v}ₜ

In some implementations, data reconstruction engine 306 may utilize a two separate bi-directional Long Short-Term Memory (LSTM) network to determine and generate missing data/values of a time series aggregate order data 311 with missing data/values. In such implementations, the bi-directional LSTM network can utilize data elements of a time series aggregate order data 311 that have known data/values to determine substitute data/values of data elements of the time series aggregate order data 311 that have missing data/values. Additionally, the bi-directional LSTM network can implement a forward layer and a backward layer to determine any discrepancies between the predicted values/data between the forward layer and backward layer.

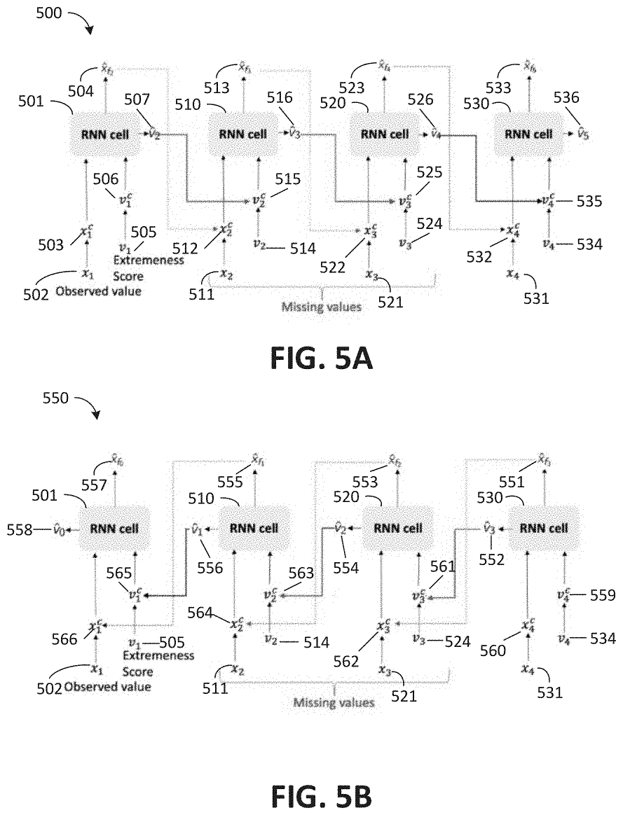

FIG. 5A illustrates an example forward layer of the RNN. As illustrated in FIG. 5A, the time series aggregate order data 311 includes data elements x₁ 502, x₂ 511, x₃ 521, and x₄ 531, and data elements x₂ 511 and x₃ 521 have missing data/values. Additionally, each RNN cell (e.g., RNN Cell 501, 510, 520 and 530) in FIG. 5A can have a similar architecture and configuration as the RNN cell illustrated and discussed with FIG. 4. Moreover, given that x₂ 511 and x₃ 521 have missing data/values, x₂ 511 and x₃ 521 also do not have a corresponding predicted extremeness score, while x₁ 502 and x₄ 531 do. As illustrated in FIG. 5, in the forward layer, RNN cell 501 can determine predicted output value 504 and corresponding predicted extremeness score 507 utilizing equations 2-10 and based on x₁ 502 and corresponding v₁ 505. Additionally, predicted output value 504 and corresponding predicted extremeness score 507 can be input data for RNN cell 510. As such, RNN cell 510, can determine predicted output value 513 and corresponding predicted extremeness score 516 utilizing equations 2-10 and based on predicted output value 504 and predicted extremeness score 507. Moreover, predicted output value 513 and corresponding predicted extremeness score 516 can be input data for RNN cell 520. As such, RNN cell 520, can determine predicted output value 523 and corresponding predicted extremeness score 526 utilizing equations 2-10 and based on predicted output value 513 and predicted extremeness score 516. Furthermore, predicted output value 523 and corresponding predicted extremeness score 526 can be input data for RNN cell 530. As such, RNN cell 530, can determine predicted output value 533 and corresponding predicted extremeness score 536 utilizing equations 2-10 and based on predicted output value 523 and predicted extremeness score 526.

FIG. 5B illustrates an example backward layer of the RNN. Following the example of FIG. 5A, FIG. 5B illustrates, in the backward layer, RNN cell 530 can determine predicted output value 551 and corresponding predicted extremeness score 552 utilizing equations 2-10 and based on x₄ 531 and corresponding v₄ 534. Additionally, predicted output value 551 and corresponding predicted extremeness score 552 can be input data for RNN cell 520. As such, RNN cell 520, can determine predicted output value 553 and corresponding predicted extremeness score 554 utilizing equations 2-10 and based on predicted output value 551 and predicted extremeness score 552. Moreover, predicted output value 553 and corresponding predicted extremeness score 554 can be input data for RNN cell 510. As such, RNN cell 510, can determine predicted output value 555 and corresponding predicted extremeness score 556 utilizing equations 2-10 and based on predicted output value 553 and predicted extremeness score 554. Furthermore, predicted output value 555 and corresponding predicted extremeness score 556 can be input data for RNN cell 501. As such, RNN cell 501, can determine predicted output value 557 and corresponding predicted extremeness score 558 utilizing equations 2-10 and based on predicted output value 555 and predicted extremeness score 556.

In some implementations, the predicted output values and corresponding predicted extremeness scores determined in the forward layer may have a discrepancy in value/score compared to corresponding predicted output values and corresponding extremeness scores determined in the backward layer. For example, predicted output value 513 and corresponding predicted extremeness score 516 may have a different value/score than predicted output value 555 and corresponding predicted extremeness score 556. Data reconstruction engine 306 can determine an adjusted predicted output values of data elements with missing data/values based on the predicted values/scores of such data elements (e.g., predicted output value 513 and corresponding predicted extremeness score 516, and predicted output value 555 and corresponding predicted extremeness score 556) and determined discrepancies or loss between the value/scores determined in the forward layer as compared to the value/scores determined in the backward layer. Additionally, the discrepancy or loss can be determined by evaluating the predicted output values and corresponding predicted extremeness scores of data elements of an original time series data (e.g., time series aggregate order data 311) that have known data/values. For example, following the examples of FIG. 5A and FIG. 5B, the data reconstruction engine 306 may utilize the predicted output values and corresponding predicted extremeness scores of x₁ and x₄ to determine the discrepancy or loss. Additionally, data reconstruction engine 306 may determine the discrepancy or loss according to the equations below.

[symbol]

ₜ=λ₁ [symbol] _{discrepancy}_{ₜ}+λ [symbol] ₂ [symbol] ₑᵥₗ_{ₜ}+λ₃ [symbol] ₒᵤₜ_{ₜ} (11)
where the loss functions are determined according to the equations below.

$${ℒ}_{{discrepency}_{i}} = {m}_{t} \cdot \text{?} + {m}_{t} \cdot \text{?} \qquad ( 12 )$$

$$\text{?} = {m}_{t} \cdot \text{?} / 2 ) \qquad ( 13 )$$

$$\text{?} = {m}_{t} \cdot \text{?} ( {x}_{t} \cdot \text{?} ) \qquad ( 14 )$$

$$\text{?} \text{indicates text missing or illegible when filed}$$

As described above, equation 12 represents the discrepancy between forward and backward estimation of observed values of xₜ (e.g., predicted output value 504, predicted output value 557, and predicted output value 533, and predicted output value 551) and vₜ (e.g., corresponding predicted extremeness score 507, corresponding predicted extremeness score 558, corresponding predicted extremeness score 536, and corresponding predicted extremeness score 552). Additionally, equation 13 represents the error in prediction of extremeness score of the observed values in vₜ(e.g., corresponding predicted extremeness score 507, corresponding predicted extremeness score 558, corresponding predicted extremeness score 536, and corresponding predicted extremeness score 552). Moreover, equation 14 represents the overall prediction error for observed values in xₜ (e.g., predicted output value 504, predicted output value 557, and predicted output value 533, and predicted output value 551).

In some implementations, the adjusted predicted output values of data elements of an original time series data set (e.g., time series aggregate order data 331) may be utilized as substitute data for data elements of data elements of original time series data set that are missing data/values. In such implementations, data imputation computing device 102 can generate a reconstructed time series data set. Additionally, the reconstructed time series data set can at least include data elements of the original time series dataset with known data/values and the substitute data/values. In some examples, based on the substitute value or data, the data reconstruction engine 306 may generate a new or substitute data element(s) with the substituted value(s) or data. Additionally, data reconstruction engine 306 may generate a reconstructed time series data set that includes data elements of the original time series dataset with known data/values and the substitute data element(s) in place of the corresponding data element(s) of the original time series data set that have missing data/value(s). For example, a second data element of the original time series data set and a fifth data element of the original time series data set may have missing data/value. Additionally, data reconstruction engine 306 may implement the one or more data reconstruction operations to generate a first substitute data/value to replace the missing data/value of the second data element and a second substitute data/value to replace the missing data/value of the fifth data element. Moreover, data reconstruction engine 306 may generate a first substitute data element with the first substitute data/value and a second substitute data element with the second substitute data value. As such, data reconstruction engine 306 generate a reconstructed time series data set that includes data element of the original time series dataset with known data/values and the first substitute data element and the second substitute data element.

In other examples, data imputation computing device 102 may add the generated substitute value/data to the corresponding data elements of the original time series data set with missing data/value. For example, a first data element of the original time series data set may have missing data/value. Additionally, data reconstruction engine 306 may implement the one or more data reconstruction operations to generate substitute data/value to replace the missing data/value of the first data element. Moreover, data reconstruction engine 306 may generate a reconstructed time series data with the data elements of the original time series, including the first data element with the missing data/value. Further, data reconstruction engine 306 may add the generated substitute data/value to the first data element of the original time series that is included in the reconstructed time series data. Each reconstructed time series data set generate by data reconstruction engine 306 may be stored in database 116 (e.g., reconstructed order data 314). Reconstructed order data 314 can include data of each reconstructed time series data set generated by data reconstruction engine 306.

In various implementations, data forecasting computing device 106 can utilize the reconstructed time series data set(s) stored in database 116 to train machine learning models (e.g., algorithms). The trained machine learning models may generate order volume forecasts or demand forecasts for a store. In various implementations, data forecasting computing device 106 may apply the trained machine learning models to the reconstructed time series dataset to generate an order volume forecast for a particular store. The machine learning model may be any suitable machine learning model, such as one based on decision trees, linear regression, logistic regression, support-vector machine (SVM), K-Means, or a deep learning model such as a neural network. The machine learning model may execute with hyperparameters selected and tuned by data forecasting computing device 106.

### Methodology

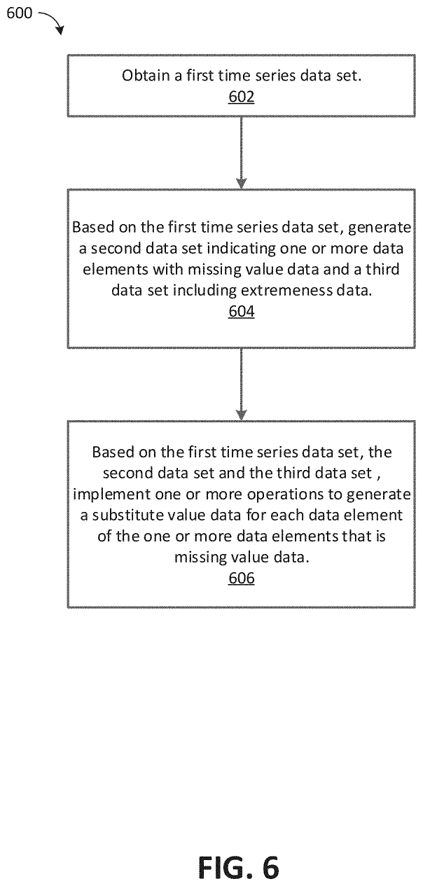

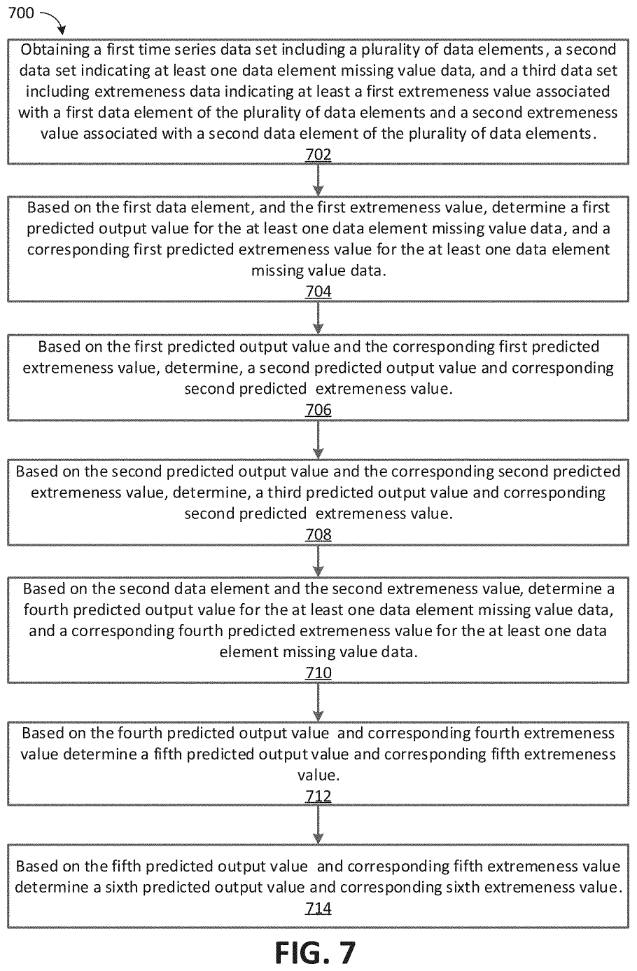

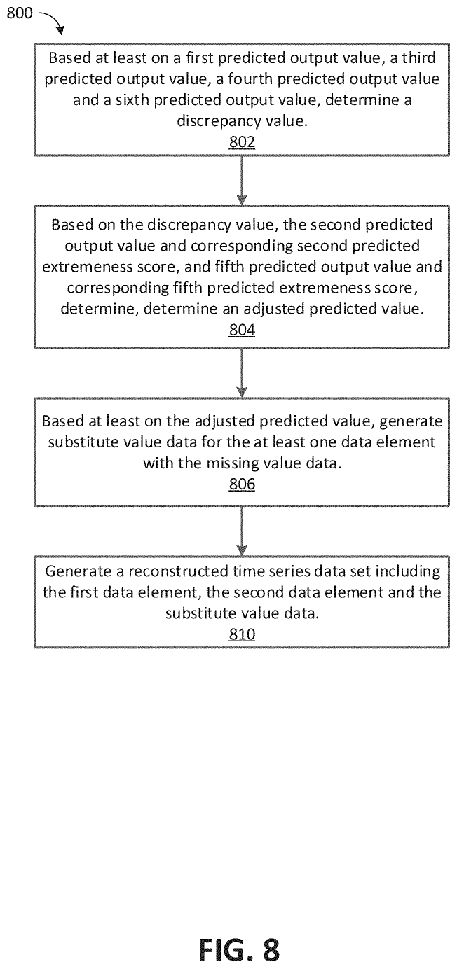

FIG. 6 illustrates an example method that can be carried out by the data imputation computing device 102. FIG. 7 illustrates another example method that can be carried out by the data imputation computing device 102. FIG. 8 illustrates another example method that can be carried out by the data imputation computing device 102. In describing an example method of FIGS. 6, 7, and 8, reference is made to elements of FIGS. 1, 3 and 5 for purpose of illustrating a suitable component for performing a step or sub-step being described.

With reference to example method 600 of FIG. 6, data imputation computing device 102 may obtain a first time series data set (602). In some examples, the first time series data set may include aggregate order data as described in herein (e.g., time series aggregate order data 311). Additionally, the first time series data set may include a plurality of data elements. Each data element of the plurality of data elements may include value data and a corresponding time data. For example, the value data can indicate the total order volume or amount that is available for pickup at a particular time and/or date and location (e.g., a particular store), while the time data can indicate that particular time and/or date. In some examples, the data elements may include additional data such as a pickup location. In such examples, the pickup location can be a particular store represented by a store identifier.

Based on the first time series data set, data imputation computing device 102 may generate a second data set indicating one or more data elements with missing value data and a third data set including extremeness data (604). In some examples, the extremeness data can indicate an extremeness score for each data element of the plurality of data elements. In other examples, pre-processing engine 302 may determine and generate the second and third data sets based on the first time series data set, such as aggregate order data 311. Additionally, based on the first time series data set, the second data set and the third data set, the data imputation computing device can implement one or more reconstruction operations to generate a substitute value data for each data element of the one or more data elements that is missing value data (606). In some examples, data reconstruction engine 306 may utilize the first time series data set, such as aggregate order data 311, the second data set and the third data set to implement one or more reconstruction operations to generate a substitute value data for each data element of the one or more data elements that is missing value data.

In various implementations, the one or more data reconstruction operations to determine and generate substitute data/values for data elements of an original time series data set, such as aggregate order data 311, with missing data/value(s). With reference to example method 700 of FIG. 7, the one or more data reconstruction operations includes, data imputation computing device 102 obtaining a first time series data set, a second data set, and a third data set (702). In some examples, the first time series data set includes a plurality of data elements including at least a first data element and a second data element. Additionally, the first data element includes at least a first value data and the second data element includes at least a second value data. In other examples, the second data set indicates at least one data element missing value data. In yet other examples, the third data set includes extremeness data. The extremeness data may indicate at least a first extremeness score associated with a first data element of the plurality of data elements and a second extremeness score associated with a second data element of the plurality of data elements.

Additionally, the one or more reconstruction operations includes, based on the first data element, and the first extremeness score, determining, by data imputation computing device 102, a first predicted output value for the at least one data element missing value data, and a corresponding first predicted extremeness score for the at least one data element missing value data (704). In some implementations, data reconstruction engine 306 may utilize a RNN to determine and generate substitute data/values for data elements of a time series aggregate order data 311. Additionally, as illustrated in FIG. 4, FIG. 5A and FIG. 5B, each RNN cell 420 may utilize equations 2-10 to determine the first predicted output value for the at least one data element missing value data, and corresponding first predicted extremeness score for the at least one data element missing value data.

Additionally, the one or more reconstruction operations includes, based on the first predicted output value and the corresponding first predicted extremeness score, determining, by the data imputation computing device 102, a second predicted output value and corresponding second predicted extremeness score (706). In some implementations, data reconstruction engine 306 may utilize a RNN to determine and generate substitute data/values for data elements of a time series aggregate order data 311. Additionally, as illustrated in FIG. 4, FIG. 5A and FIG. 5B, each RNN cell 420 may utilize equations 2-10 to determine the second predicted output value, and corresponding second predicted extremeness score.

Additionally, the one or more reconstruction operations includes, based on the second predicted output value and the corresponding second predicted extremeness score, determining, by the data imputation computing device 102, a third predicted output value and corresponding third predicted extremeness score (708). In some implementations, data reconstruction engine 306 may utilize a RNN to determine and generate substitute data/values for data elements of a time series aggregate order data 311. Additionally, as illustrated in FIG. 4, FIG. 5A and FIG. 5B, each RNN cell 420 may utilize equations 2-10 to determine the third predicted output value, and corresponding third predicted extremeness score.

Additionally, the one or more reconstruction operations includes, based on the second data element and the second extremeness score, determining, by the data imputation computing device 102, a fourth predicted output value for the at least one data element missing value data, and corresponding third predicted extremeness score for the at least one data element missing value data (710). In some implementations, data reconstruction engine 306 may utilize a RNN to determine and generate substitute data/values for data elements of a time series aggregate order data 311. Additionally, as illustrated in FIG. 4, FIG. 5A and FIG. 5B, each RNN cell 420 may utilize equations 2-10 to determine the fourth predicted output value for the at least one data element missing value data, and corresponding fourth predicted extremeness score for the at least one data element missing value data.

Additionally, the one or more reconstruction operations includes, based on the fourth predicted output value and the corresponding fourth predicted extremeness score, determining, by the data imputation computing device 102, a fifth predicted output value and corresponding fifth predicted extremeness score (712). In some implementations, data reconstruction engine 306 may utilize a RNN to determine and generate substitute data/values for data elements of a time series aggregate order data 311. Additionally, as illustrated in FIG. 4, FIG. 5A and FIG. 5B, each RNN cell 420 may utilize equations 2-10 to determine the fifth predicted output value, and corresponding fifth predicted extremeness score.

Additionally, the one or more reconstruction operations includes, based on the fifth predicted output value and the corresponding fifth predicted extremeness score, determining, by the data imputation computing device 102, a sixth predicted output value and corresponding sixth predicted extremeness score (714). In some implementations, data reconstruction engine 306 may utilize a RNN to determine and generate substitute data/values for data elements of a time series aggregate order data 311. Additionally, as illustrated in FIG. 4, FIG. 5A and FIG. 5B, each RNN cell 420 may utilize equations 2-10 to determine the sixth predicted output value, and corresponding sixth predicted extremeness score.

Example method 800 of FIG. 8, illustrates additional data reconstruction operations for determining and generating substitute data/values for data elements of an original time series data set, such as aggregate order data 311, with missing data/value(s). With reference to example method 800 of FIG. 8, the one or more data reconstruction operations includes, determining, by data imputation computing device 102, a discrepancy value, based at least on first predicted output value, third predicted output value, fourth predicted output value and sixth predicted output value (802). In some examples, the discrepancy value can be further based at least on first predicted extremeness score, third predicted extremeness score, fourth predicted extremeness score and sixth predicted extremeness score. In various implementations. In other examples, data reconstruction engine 306 may determine the discrepancy value or loss value according to equations 11-14.

Additionally, the one or more reconstruction operations includes, determining, by data imputation computing device 102, an adjusted predicted value of the at least one data element with missing data/value, based on the discrepancy value, the second predicted output value and corresponding second predicted extremeness score, and fifth predicted output value and corresponding fifth predicted extremeness score (804). In some examples, data reconstruction engine 306 can determine the adjusted predicted value of the at least one data element with missing data/value, based on the discrepancy value, the second predicted output value and corresponding second predicted extremeness score, and fifth predicted output value and corresponding fifth predicted extremeness score.

Moreover, based at least on the adjusted predicted value, data imputation computing device 102, can generate substitute value data for the at least one data element with the missing value data (806). In some examples, data reconstruction engine 306 can generate substitute value date for the at least one data element with the missing value data based at least on the adjusted predicted value. Furthermore, data imputation computing device 102 may generate a reconstructed time series data set including the first data element, the second data element and substitute value data (808). In some examples, data reconstruction engine 306 can generate a new or substitute data element with the substitute value data to replace the at least one data element with the missing data/value in the reconstructed time series data set. In other examples, data reconstruction engine 306 can generate a reconstructed time series data set with the data elements of the original time series data set, including the at least one data element with the missing data/value. Additionally, data reconstruction engine 306 can add the substitute value data to the at least one data element with the missing data/value to replace the missing data/value.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The term model as used in the present disclosure includes data models created using machine learning. Machine learning may involve training a model in a supervised or unsupervised setting. Machine learning can include models that may be trained to learn relationships between various groups of data. Machine learned models may be based on a set of algorithms that are designed to model abstractions in data by using a number of processing layers. The processing layers may be made up of non-linear transformations. The models may include, for example, artificial intelligence, neural networks, deep convolutional and recurrent neural networks. Such neural networks may be made of up of levels of trainable filters, transformations, projections, hashing, pooling and regularization. The models may be used in large-scale relationship-recognition tasks. The models can be created by using various open-source and proprietary machine learning tools known to those of ordinary skill in the art.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
one or more processors; and
a memory resource storing instructions, that when executed by the one or more processors, causes the one or more processors to:
obtain a first time series data set, the first time series data set including a plurality of data elements, each data element including value data and corresponding time data;
based on the first time series data set, generate a second data set and a third data set, the second data set indicating one or more data elements of the plurality of data elements that are missing value data and the third data set including extremeness data indicating an extremeness score for each data element of the plurality of data elements; and
based on the first time series data set, the second data set and the third data set, implement a set of operations that generate a substitute value data for each data element of the one or more data elements that are missing value data.

2. The system of claim 1, wherein the one or more processors execute the instruction to further:
for each data element of the plurality of data elements that are missing value data, replace the data element with the corresponding substitute value data.

3. The system of claim 1, wherein implementing the set of operations includes utilizing a Recurrent Neural Network (RNN).

4. The system of claim 3, wherein the RNN may include two separate bi-directional Long Short-Term Memory network.

5. The system of claim 1, wherein the set of operations that generate the substitute value data for each data element of the one or more data elements that are missing value data include:
in a forward layer, determining a first set of predicted output values and a first set of predicted extremeness scores based on the first time series data set and the third data set.

6. The system of claim 5, wherein the plurality of data elements of the first time series data set includes at least a first data element and a second data element, and the extremeness data of the third data set includes at least a first extremeness value associated with the first data element and a second extremeness value associated with the second data element.

7. The system of claim 6, wherein determining the first set of predicted output values and the first set of predicted extremeness scores includes:
based on the first data element and the first extremeness value, determining a first predicted output value for at least one data element missing value data and corresponding first predicted extremeness value for the at least one data element missing value data.

8. The system of claim 7, wherein determining the first set of predicted output values and the first set of predicted extremeness scores further includes:
based on the first predicted output value and the corresponding first predicted extremeness value, determining, a second predicted output value for at least another data element missing value data and corresponding second predicted extremeness value.

9. The system of claim 5, wherein the set of operations that generate the substitute value data for each data element of the one or more data elements that are missing value data include:
in a backward layer, determining a second set of predicted output values and a second set of predicted extremeness scores based on the first time series data set and the third data set.

10. The system of claim 9, wherein the set of operations that generate the substitute value data for each data element of the one or more data elements that are missing value data further include:
based at least on the first set of predicted output values, the first set of predicted extremeness scores, the second set of predicted output values and the second set of predicted extremeness scores, generating discrepancy data.

11. A computer-implemented method comprising:
obtaining a first time series data set, the first time series data set including a plurality of data elements, each data element including value data and corresponding time data;
based on the first time series data set, generating a second data set and a third data set, the second data set indicating one or more data elements with missing value data and the third data set including extremeness data indicating an extremeness score for each data element of the plurality of data elements; and
based on the first time series data set, the second data set and the third data set, implementing one or more operations to generate a substitute value data for each data element of the one or more data elements that is missing value data.

12. The computer-implemented method of claim 11, further comprising:
for each data element of the plurality of data elements that are missing value data, replace the data element with the corresponding substitute value data.

13. The computer-implemented method of claim 11, wherein implementing the set of operations includes utilizing a Recurrent Neural Network (RNN) when implementing the set of operations.

14. The computer-implemented method of claim 13, wherein the RNN may include two separate bi-directional Long Short-Term Memory network.

15. The system of computer-implemented method 11, wherein the set of operations that generate the substitute value data for each data element of the one or more data elements that are missing value data include:
in a forward layer, determining a first set of predicted output values and a first set of predicted extremeness scores based on the first time series data set and the third data set.

16. The computer-implemented method of claim 15, wherein the plurality of data elements of the first time series data set includes at least a first data element and a second data element, and the extremeness data of the third data set includes at least a first extremeness value associated with the first data element and a second extremeness value associated with the second data element.

17. The computer-implemented method of claim 16, wherein determining the first set of predicted output values and the first set of predicted extremeness scores includes:
based on the first data element and the first extremeness value, determining a first predicted output value for at least one data element missing value data and corresponding first predicted extremeness value for the at least one data element missing value data.

18. The computer-implemented method of claim 17, wherein determining the first set of predicted output values and the first set of predicted extremeness scores further includes:
based on the first predicted output value and the corresponding first predicted extremeness value, determining, a second predicted output value for at least another data element missing value data and corresponding second predicted extremeness value.

19. The computer-implemented method of claim 15, wherein the set of operations that generate the substitute value data for each data element of the one or more data elements that are missing value data include:
in a backward layer, determining a second set of predicted output values and a second set of predicted extremeness scores based on the first time series data set and the third data set; and
based at least on the first set of predicted output values, the first set of predicted extremeness scores, the second set of predicted output values and the second set of predicted extremeness scores, generate discrepancy data.

20. A non-transitory computer readable medium having instructions stored thereon, wherein the instructions, when executed by one or more processors, cause a computing device to:
obtain a first time series data set, the first time series data set including a plurality of data elements, each data element including value data and corresponding time data;
based on the first time series data set, generate a second data set and a third data set, the second data set indicating one or more data elements with missing value data and the third data set including extremeness data indicating an extremeness score for each data element of the plurality of data elements; and
based on the first time series data set, the second data set and the third data set, implement one or more operations to generate a substitute value data for each data element of the one or more data elements that is missing value data.
